(19) United States
(12) Patent Application Publication
(10) Pub. No.: US 2020/0122507 A1
(43) Pub. Date: Apr. 23, 2020

(54) TIRE WITH OPTIMIZED CROWN AND TREAD

(71) Applicant: COMPAGNIE GENERALE DES ETABLISSEMENTS MICHELIN, Clermont-Ferrand (JP)

(72) Inventors: AYMERIC BONNET, Clermont-Ferrand (FR); FRÉDÉRIC BOURGEOIS, Clermont-Ferrand (FR)

(21) Appl. No.: 16/612,508

(22) PCT Filed: Apr. 25, 2018
(86) PCT No.: PCT/FR2018/051044

§ 371 Date: Nov. 11, 2019

(30) Foreign Application Priority Data
May 11, 2017 (FR) 1754133

(51) Int. Cl. B60C 9/00; B60C 11/04; B60C 9/20

(52) U.S. Cl. CPC B60C 9/0064; B60C 11/04; B60C 2011/1213; B60C 2009/209; B60C 9/2009

(57) ABSTRACT

Tires comprising a hoop reinforcement (5) and 2 crossed working layers (41, 42) in which the breaking strength R_{C} of each working layer (41, 42) is at least equal to 30 000 N/dm have improved endurance. The working layers comprise reinforcing elements made up of individual metal threads or monofilaments having a cross section at least equal to 0.20 mm and at most equal to 0.5 mm. The density of reinforcing elements in each working layer is at least equal to 100 threads per dm and at most equal to 200 threads per dm. The tire also comprises axially exterior cuts (25). At least one of the two axially exterior portions of the tread comprises a rubbery material having a Shore hardness at least equal to 48 and at most equal to 60.

### FIELD OF THE INVENTION

The present invention relates to a passenger vehicle tyre, and more particularly to the crown of such a tyre.

As a tyre has a geometry of revolution about an axis of rotation, the geometry of the tyre is generally described in a meridian plane containing the axis of rotation of the tyre. For a given meridian plane, the radial, axial and circumferential directions denote the directions perpendicular to the axis of rotation of the tyre, parallel to the axis of rotation of the tyre and perpendicular to the meridian plane, respectively.

In the following text, the expressions “radially on the inside of” and “radially on the outside of” mean “closer to the axis of rotation of the tyre, in the radial direction, than” and “further away from the axis of rotation of the tyre, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tyre and an “axial distance” is a distance with respect to the equatorial plane of the tyre. A “radial thickness” is measured in the radial direction and an “axial width” is measured in the axial direction.

A tyre comprises a crown comprising a tread that is intended to come into contact with the ground via a tread surface, two beads that are intended to come into contact with a rim, and two sidewalls that connect the crown to the beads. Furthermore, a tyre comprises a carcass reinforcement, comprising at least one carcass layer, radially on the inside of the crown and connecting the two beads.

The tread of a tyre is delimited, in the radial direction, by two circumferential surfaces of which the radially outermost is referred to as the tread surface and of which the radially innermost is referred to as the tread pattern bottom surface. In addition, the tread of a tyre is delimited, in the axial direction, by two lateral surfaces. The tread is also made up of one or more rubber compounds. The expression “rubber compound” refers to a composition of rubber comprising at least an elastomer and a filler.

The crown comprises at least one crown reinforcement radially on the inside of the tread. The crown reinforcement comprises at least one working reinforcement comprising at least one working layer made up of mutually parallel reinforcing elements that form, with the circumferential direction, an angle of between 15° and 50°. The crown reinforcement may also comprise at least one hooping layer made up of reinforcing elements that form, with the circumferential direction, an angle of between 0° and 10°, the hoop reinforcement usually, but not necessarily, being radially on the outside of the working layers.

In order to obtain good grip on wet ground, cuts are made in the tread. A cut denotes either a well, or a groove, or a sipe, or a circumferential groove, and forms a space opening onto the tread surface. On the tread surface, a well has no characteristic main dimension. A sipe or a groove has, on the tread surface, two characteristic main dimensions: a width W and a length Lo, such that the length Lo is at least equal to twice the width W. A sipe or a groove is therefore delimited by at least two main lateral faces determining its length Lo and connected by a bottom face, the two main lateral faces being distant from one another by a non-zero distance referred to as the width W of the sipe or of the groove.

By definition, a sipe or a groove which is delimited by:
only two main lateral faces is said to be open-ended,
by three lateral faces, two of them being main faces determining the length of the cut, is said to be blind,
by four lateral faces, two of them being main faces determining the length of the cut, is said to be double-blind.

The difference between a sipe and a groove is the value of the mean distance separating the two main lateral faces of the cut, namely its width W. In the case of a sipe, this distance is suitable for allowing the two mutually-facing main lateral faces to come into contact when the sipe enters the contact patch in which the tyre is in contact with the road surface. In the case of a groove, the main lateral faces of this groove cannot come into contact with one another under usual running conditions. This distance for a sipe is generally, for passenger vehicle tyres, at most equal to 1 millimetre (mm). A circumferential groove is a cut of substantially circumferential direction that is substantially continuous over the entire circumference of the tyre.

More specifically, the width W is the mean distance, determined along the length of the cut and along a radial portion of the cut, comprised between a first circumferential surface, radially on the inside of the tread surface at a radial distance of 1 mm, and a second circumferential surface, radially on the outside of the bottom surface at a radial distance of 1 mm, so as to avoid any measurement problem associated with the junctions at which the two main lateral faces meet the tread surface and the bottom surface.

The depth of the cut is the maximum radial distance between the tread surface and the bottom of the cut. The maximum value of the depths of the cuts is referred to as the tread depth D. The tread pattern bottom surface, or bottom surface, is defined as being the surface of the tread surface translated radially inwards by a radial distance equal to the tread depth.

### STATE OF THE ART

In the current context of sustainable development, the saving of resources and therefore of raw materials is one of the industry's key objectives. For passenger vehicle tyres, one of the avenues of research for achieving this objective is to replace the metal cords usually employed as reinforcing elements in various layers of the crown reinforcement with individual threads or monofilaments as described in document EP 0043563 in which this type of reinforcing element is used with the twofold objective of saving weight and lowering rolling resistance.

However, the use of this type of reinforcing element has the disadvantage of causing these monofilaments to buckle under compression, causing the tyre to exhibit insufficient endurance, as described in document EP2537686. As that same document describes, a person skilled in the art proposes a particular layout of the various layers of the crown reinforcement and a specific quality of the materials that make up the reinforcing elements of the crown reinforcement in order to solve this problem.

A detailed analysis of the physical phenomenon shows that the buckling of the monofilaments occurs in the axially outermost parts of the tread underneath the cuts, as mentioned in documents JP 2012071791, EP2016 075729, EP 2016 075721, EP 2016 075725, EP 2016 075741. This region of the tyre has the particular feature of being subjected to high compression loadings when the vehicle is running in a curved line. The resistance of the monofilaments to buckling is dependent on the geometry of the cuts, thus demonstrating the surprising influence that the tread pattern has on the endurance of the monofilaments.

### SUMMARY OF THE INVENTION

The main objective of the present invention is therefore to improve the endurance of a tyre in which the reinforcing elements of the working layers are made up of monofilaments through the design of a suitable tread.

This objective is achieved by a passenger vehicle tyre comprising:
a tread intended to come into contact with the ground via a tread surface and having an axial width LT,
the tread comprising two axially exterior portions each having an axial width at most equal to 0.3 times the axial width LT, comprising at least one rubbery material M intended to come into contact with the ground during running,
at least one axially exterior portion comprising axially exterior cuts, an axially exterior cut forming a space opening onto the tread surface and being delimited by at least two lateral faces referred to as main lateral faces connected by a bottom face,
the axially exterior cuts having a depth D defined by the maximum radial distance between the tread surface and the bottom face,
the tyre further comprising a crown reinforcement radially on the inside of the tread,
the crown reinforcement comprising a working reinforcement and a hoop reinforcement,
the working reinforcement being made up of 2 working layers each comprising reinforcing elements which are coated in an elastomeric material, mutually parallel and respectively form, with a circumferential direction (XX′) of the tyre, an oriented angle (A1, A2) at least equal to 20° and at most equal to 50°, in terms of absolute value, and of opposite sign from one layer to the next,
the said reinforcing elements in each ply being made up of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction (XX′) of the tyre, an angle B at most equal to 10°, in terms of absolute value,
the breaking strength R_{C} of each working layer is at least equal to 30 000 N/dm, R_{C} being defined by: R_{C}=Rm*S*d, where Rm is the tensile breaking strength of the monofilaments in MPa, S is the cross-sectional area of the monofilaments in mm² and d is the density of monofilaments in the working layer considered, in number of monofilaments per dm,
in at least one of the two axially exterior portions (LS1, LS2), the at least one rubbery material M intended to be in contact with the ground, has a Shore hardness at least equal to 48 and at most equal to 60.

Usually, the main lateral faces are substantially the same shape and spaced apart from one another by a distance equal to the width W of the cut. The greater the width W of the cuts in the axially exterior portions, the more the monofilaments are sensitive to buckling. Nevertheless, the invention improves the endurance of the monofilaments of the tyre regardless of the width of the cuts.

From a mechanical operation standpoint, the buckling of a reinforcing element occurs in compression. It occurs only in that part of the working layers that is radially on the inside of the axially outermost portions of the tread because it is in this zone that the compressive loadings are highest in the event of transverse loading. These axially outermost portions each have as their maximum axial width 0.3 times the total width of the tread of the tyre.

Buckling is a complex and unstable phenomenon which leads to fatigue rupture of an object that has at least one dimension one order of magnitude smaller than a main dimension, such as beams or shells. Monofilaments are objects of this type with a cross section very much smaller than their length. The phenomenon begins when the main dimension is placed under compression. It continues because of the asymmetry of geometry of the monofilament, or because of the existence of a transverse force caused by the bending of the monofilament, which is a stress loading that is highly destructive for metallic materials. This complex phenomenon is notably highly dependent on the boundary conditions, on the mobility of the element, on the direction of the applied load and on the deformation resulting from this load. If this deformation does not take place substantially in the direction of the main dimension of the monofilament, then buckling will not occur and, in the case of monofilaments surrounded by a matrix of rubber compound such as those of the working layers of a tyre, the load is absorbed by the shearing of the rubber compound between the monofilaments.

Moreover, buckling of the monofilaments of the working layers only occurs in the most flexible portions of the tread. These portions may correspond to axially exterior portions of the tread comprising axially exterior cuts.

In the case of the cuts that are not axially exterior, the compressive loading in the case of transverse loading of the tyre is too low to cause buckling.

The axially exterior cuts may be of any shape, curved, sinusoidal, zigzag, and thus may or may not, through suitable design, allow relative movements of their main lateral faces during running. In order to prevent relative movement of the main lateral faces of a cut, it may be enough to create a tread pattern element that is such that one of the faces will come to bear against the other when the movement in question is going to occur. Small-width cuts, or sipes which are zigzag or sinusoidal in shape along the length of the sipe, if the two main lateral faces are designed to come to bear against one another, are examples of this type of cut. If the waviness of the sipe is in the depth direction, the relative radial movements of the main lateral faces will be blocked. If the sipe has double waviness in the direction of its length and in the depth direction, then both movements will be blocked. In as much as it is a large deformation of the crown that causes the monofilaments of the working layers to buckle and notably those permitted by the tread pattern, any blocking of movement within the tread pattern may lead to an improvement in the endurance performance of the monofilaments.

All of these cut design parameters have constraints and disadvantages, such as:
the price of the curing moulds for the tyre that is directly linked to the complexity of the mould elements that create complex, zigzag or sinusoidal, cuts, also referred to as sipe blades.
The difficulty of demoulding from the curing mould for cuts of which the undulation is in the depth-wise direction and tends to retain the sipe blades of the mould. This geometry can create a local tear in the tread and make the tyre unsaleable.

Therefore, it is advantageous to find other parameters than the design of the geometry of the cuts in order to improve the endurance of the tyre to buckling. Furthermore, even when using all of these cut geometries, for tyres that are heavily loaded or very lightweight in order to reduce the raw material costs thereof or to improve the rolling resistance thereof, it is advantageous to be able to improve the resistance of the monofilaments to buckling through another design parameter.

To achieve these objectives, surprisingly, it is advantageous to use, in one of the two axially exterior portions (LS1, LS2), preferably the one most heavily loaded in the tread, as the material intended to be in contact with the ground, a rubbery material having low stiffness, namely such that its Shore hardness, measured in accordance with standard ASTM 2240 or DIN 53505, is at least equal to 48 and at most equal to 60. A material intended to be in contact with the ground is a material of the tread in contact with the ground in the new state or in the worn state of the tyre but in normal usage on a vehicle, under conditions of legal and safe wear of the tyre.

According to the invention, one or both of the two exterior portions (LS1, LS2) of the tread may comprise such a material and other rubbery materials having other mechanical properties on specific portions of the tread, with objectives—for example—of improving the localized wear or the endurance of the tread. According to the invention, the entire tread could be made up of this rubbery material, if only with the objective of lowering the manufacturing cost.

The two axially exterior portions of the tread may potentially contain one or more circumferential grooves in order to reduce the risk of aquaplaning on wet ground. For passenger vehicle tyres, these circumferential grooves generally represent a small width of the contact patch and have no known impact on the buckling of the monofilaments.

The monofilaments may have any cross-sectional shape, in the knowledge that oblong cross sections represent an advantage over circular cross sections, even when of smaller size, because their inertia in bending and, therefore, their resistance to buckling, are higher. In the case of a circular cross section, the smallest dimension corresponds to the diameter of the cross section. In order to guarantee the fatigue breaking strength of the monofilaments and the resistance to shearing of the rubber compounds situated between the filaments, the density of reinforcing elements of each working layer is at least equal to 100 threads per dm and at most equal to 200 threads per dm. What is meant by the density is the mean number of monofilaments over a 10-cm width of the working layer, this width being measured perpendicularly to the direction of the monofilaments in the working layer considered. The distance between consecutive reinforcing elements may be fixed or variable. The reinforcing elements may be laid during manufacture either in layers, in strips, or individually.

Moreover, the resistance of a monofilament to buckling is also dependent on the resistance of the axially adjacent filaments, the onset of buckling in one being able to lead to the buckling of another through the effect of a distribution of load around the monofilament that is buckling. In order to obtain improved endurance performance, it is appropriate not only to observe monofilament density and diameter conditions but also to satisfy a condition relating to the strength of the working layer, namely the breaking strength R_{c} of each working layer which needs to be at least equal to 30000N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

For a tyre for which no specific direction of mounting is imposed, one solution involves applying the invention to the two axially outermost portions of the tread.

For a tyre for which a specific direction of mounting is imposed, one option is to apply the invention to only that axially outermost portion of the tread that is situated on the outboard side of the vehicle.

The tread patterns of passenger vehicle tyres are usually either substantially symmetric or substantially antisymmetric, or substantially asymmetric.

A rubbery material M of the tread, intended to be in contact with the ground, which is flexible, namely such that its Shore hardness is at least equal to 48 and at most equal to 60, is often penalized in terms of its wear performance on account of its flexibility. However, such a flexible rubbery material is characterized possibly by low hysteresis, i.e. has a dynamic property tan(δ)max measured at 23° C. at least equal to 0.12 and at most equal to 0.30.

The dynamic property tan(δ)max is measured on a viscosity analyser (Metravib VA4000), according to standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, at 23° C., is recorded. A strain amplitude sweep is carried out from 0% to 50% (outward cycle) and then from 50% to 0% (return cycle). For the return cycle, the maximum observed value, tan(δ)max, of tan(δ) is measured. The lower the value of tan(δ) at 23° C., the better the rolling resistance of the tyre.

This characteristic associated with a suitable tread pattern can result in an improvement in the rolling resistance. Since the use of monofilaments aims to save weight and to improve the rolling resistance, it is advantageous to use rubbery materials having this hysteretic property for the invention.

It is advantageous for an axially exterior cut to open axially to the outside of an axially exterior portion of the tread so as to be able to remove the water stored in the cut to outside of the contact patch if running on a wet road surface.

For preference, when the tread comprises at least one circumferential groove, an axially exterior cut opens axially on the inside of a circumferential groove of the tread so as to be able to remove the water stored in the cut to the main water storage means if running on a wet road surface.

It is advantageous for the grip that at least one of the axially exterior portions of the tread has cuts of which the depth is similar to the thickness of the tread in order to ensure the grip performance of the tyre in the worn state, namely cuts with a depth D at least equal to 5 mm and spaced apart, in the circumferential direction (XX′) of the tyre, by a circumferential spacing P at least equal to 4 mm. The circumferential spacing is the mean circumferential distance, over the axially outermost portion considered of the tread between the mean linear profiles of two circumferentially consecutive axially exterior cuts. Usually, the treads of tyres may have circumferential spacings that are variable notably so as to limit road noise.

For grip performance, it is also preferable for the axially exterior cuts to be spaced apart, in the circumferential direction (XX′) of the tyre, by a circumferential spacing P at most equal to 50 mm, so as to avoid too low a density of the cuts, leading to inadequate grip performance.

A preferred solution is that an axially exterior cut is bridged. A bridge of rubber in a cut corresponds to a local reduction in the depth of this cut. This solution makes it possible to limit the relative movements of the main lateral faces in all directions. On the other hand, they have the disadvantage of preventing flattening and thus of penalizing the rolling resistance and countering the flow of water in the bottom of the cut. In order make flattening easier and thus to improve the rolling resistance, the bridges of rubber may have a sipe.

For preference, the depth D of the axially exterior cuts is at most equal to 8 mm in order to prevent excessive tread pattern flexibility and performance losses in terms of wear and in terms of rolling resistance.

It is particularly advantageous for the radial distance D1 between the bottom face of the axially exterior cuts and the crown reinforcement to be at least equal to 1 mm. This is because this minimal quantity of rubbery materials protects the crown from attack and puncturing by obstacles, stones, or any debris lying on the ground.

It is preferable for the radial distance D1 between the bottom face of the axially exterior cuts and the crown reinforcement to be at most equal to 3.5 mm in order to obtain a tyre that performs well in terms of rolling resistance.

A preferred solution, notably for performance in terms of noise, is that all the axially exterior cuts are sipes.

Advantageously, the two axially exterior portions of the tread each have an axial width (LS1, LS2) at most equal to 0.2 times the axial width LT of the tread.

For preference, each working layer comprises reinforcing elements made up of individual metal threads or monofilaments having a cross section the smallest dimension of which is at least equal to 0.3 mm and at most equal to 0.37 mm, which constitute an optimum for balancing the target performance aspects: weight saving and buckling endurance of the reinforcing elements of the working layers.

One preferred solution is for each working layer to comprise reinforcing elements which form, with the circumferential direction (XX′) of the tyre, an angle at least equal to 22° and at most equal to 35°, which constitute an optimal compromise between tyre behaviour and tyre endurance performance.

It is advantageous for the density of reinforcing elements in each working layer to be at least equal to 120 threads per dm and at most equal to 180 threads per dm in order to guarantee the endurance of the rubber compounds working in shear between the reinforcing elements and the tension and compression endurance thereof.

The reinforcing elements of the working layers may or may not be rectilinear. They may be preformed, of sinusoidal, zigzag, or wavy shape, or following a spiral. The reinforcing elements of the working layers are made of steel, preferably carbon steel such as those used in cords of the “steel cords” type, although it is of course possible to use other steels, for example stainless steels, or other alloys.

When a carbon steel is used, its carbon content (% by weight of steel) is preferably in a range from 0.8% to 1.2%. The invention is particularly applicable to steels of the very high strength, referred to as “SHT” (“Super High Tensile”), ultra-high strength, referred to as “UHT” (“Ultra High Tensile”) or “MT” (“Mega Tensile”) steel cord type. The carbon steel reinforcers then have a tensile breaking strength (Rm) which is preferably higher than 3000 MPa, more preferably higher than 3500 MPa. Their total elongation at break (At), which is the sum of the elastic elongation and the plastic elongation, is preferably greater than 2.0%.

As far as the steel reinforcers are concerned, the measurements of breaking strength, denoted Rm (in MPa), and elongation at break, denoted At (total elongation in %), are taken under tension in accordance with ISO standard 6892 of 1984.

The steel used, whether it is in particular a carbon steel or a stainless steel, may itself be coated with a layer of metal, which improves for example the workability of the steel monofilament or the wear properties of the reinforcer and/or of the tyre themselves, such as properties of adhesion, corrosion resistance, or resistance to ageing. According to one preferential embodiment, the steel used is covered with a layer of brass (Zn—Cu alloy) or of zinc; it will be recalled that, during the process of manufacturing the threads, the brass or zinc coating makes the thread easier to draw, and makes the thread adhere to the rubber better. However, the reinforcers could be covered with a thin layer of metal other than brass or zinc, having for example the function of improving the corrosion resistance of these threads and/or their adhesion to the rubber, for example a thin layer of Co, Ni, Al, of an alloy of two or more of the Cu, Zn, Al, Ni, Co, Sn compounds.

Preferably, the reinforcing elements of the at least one hooping layer are made of textile of aliphatic polyamide, aromatic polyamide, combination of aliphatic polyamide and of aromatic polyamide, polyethylene terephthalate or rayon type, because textile materials are particularly well-suited to this type of use on account of their low mass and high stiffness. The distance between consecutive reinforcing elements in the hooping layer may be fixed or variable. The reinforcing elements may be laid during manufacture either in layers, in strips, or individually.

It is advantageous for the hoop reinforcement to be radially on the outside of the working reinforcement in order to ensure good endurance of the latter.

### BRIEF DESCRIPTION OF THE DRAWINGS

The features and other advantages of the invention will be understood better with the aid of FIGS. 1 to 3, the said figures being drawn not to scale but in a simplified manner so as to make it easier to understand the invention:

FIG. 1 is a perspective view depicting part of the tyre according to the invention, particularly its architecture and its tread.

FIG. 2 depicts the meridian section through the crown and illustrates the axially exterior parts 22 and 23 of the tread, and the width thereof.

FIGS. 3A and 3B depict two types of radially exterior meridian profile of the tread of a passenger vehicle tyre.

### DETAILED DESCRIPTION OF THE DRAWINGS

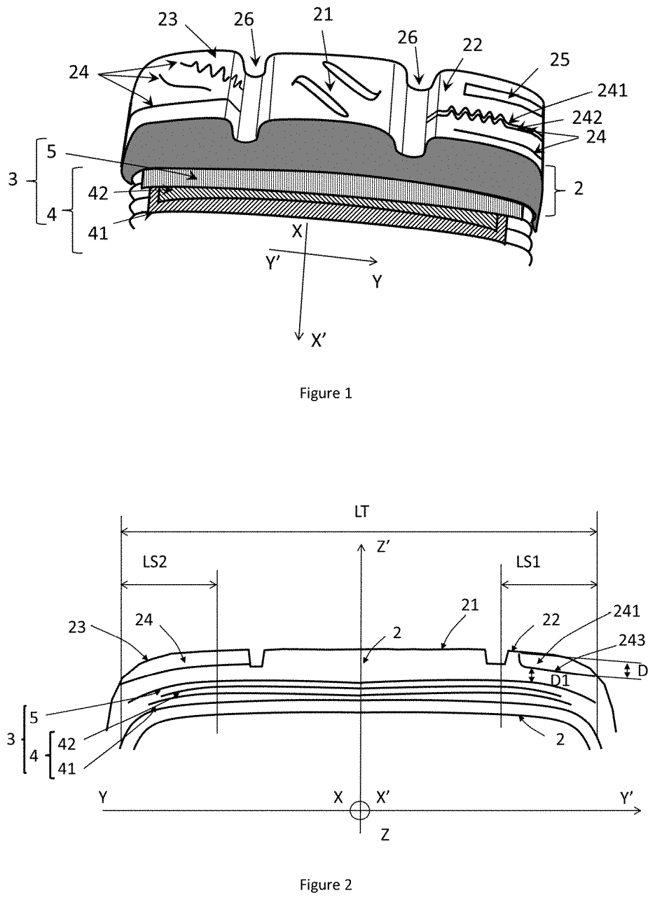

FIG. 1 depicts part of the crown of a tyre. The tyre comprises a tread 2 which is intended to come into contact with the ground via a tread surface 21. In the axially exterior portions 22 and 23 of the tread, there are major grooves 26, axially exterior cuts including sipes 24 and grooves 25. The tyre further comprises a crown reinforcement 3 comprising a working reinforcement 4 and a hoop reinforcement 5, the working reinforcement comprising 2 working layers 41 and 42. FIG. 1 further depicts double-blind cuts, blind cuts, cuts that open axially externally or internally of simple and complex type, namely having parallel lateral faces or lateral faces with zigzag or sinusoidal portions in the main direction of the cut or in its depth, so as to block certain relative movements of the 2 lateral faces.

FIG. 1 depicts, in the axially exterior parts 22 and 23 of the tread, only axially exterior grooves that are axial, along the axial axis (YY′). In actual fact, this depiction is purely for the sake of convenience for the readability of FIG. 1, it being possible, depending on the target performance, notably in terms of wet grip, for the axially exterior grooves in the treads of passenger vehicles to make an angle of between plus or minus 60° with the axial direction (YY′).

FIG. 2 schematically depicts a meridian section through the crown of the tyre according to the invention. It illustrates in particular the widths LS1 and LS2 of the axially exterior portions 22 and 23 of the tread, and the total width of the tread of the tyre LT. The depth D of an axially exterior cut 24, 25, and the distance D1 between the bottom face 243 of an axially exterior cut 24 and the crown reinforcement 3, measured along a meridian section of the tyre, are also depicted. A meridian section through the tyre is obtained by cutting the tyre on two meridian planes. By way of example, a meridian section of tyre has a thickness in the circumferential direction of around 60 mm at the tread. The measurement is taken with the distance between the two beads being kept identical to that of the tyre mounted on its rim and lightly inflated.

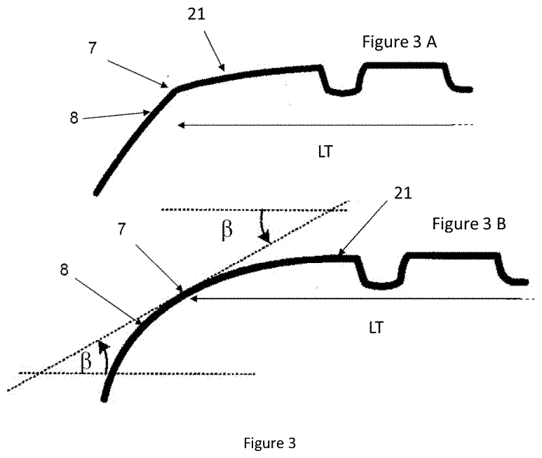

In FIGS. 3A and 3B, the axial edges 7 of the tread, that make it possible to measure the tread width, are determined. In FIG. 3A, in which the tread surface 21 intersects the outer axial surface of the tyre 8, the axial edge 7 is determined trivially by a person skilled in the art. In FIG. 3B, in which the tread surface 21 is continuous with the outer axial surface of the tyre 8, the tangent to the tread surface at any point on said tread surface in the region of transition towards the sidewall is plotted on a meridian section of the tyre. The first axial edge 7 is the point for which the angle β between the said tangent and an axial direction YY′ is equal to 30°. When there are several points for which the angle J between the said tangent and an axial direction is equal to 30°, it is the radially outermost point that is adopted. The same approach is used to determine the second axial edge of the tread.

The inventors have performed calculations on the basis of the invention for a tyre of size 205/55 R16, inflated to a pressure of 2 bar, comprising two working layers comprising steel monofilaments of diameter 0.3 mm, distributed at a density of 158 threads to the dm and forming, with the circumferential direction XX′, angles respectively equal to 25° and −25°. The monofilaments have a breaking strength Rₘ equal to 3500 MPa and the working layers each have a breaking strength R_{c} equal to 39 000 N/dm. The tyre comprises axially exterior cuts on the two axially exterior portions of the tread of the tyre that have an axial width equal to 0.21 times the axial width of the tread. The radial distance D1 between the bottom face of the axially exterior cuts and the crown reinforcement is at least equal to 2 mm.

Calculations were performed on various tyres. Tyre A, which does not conform to the invention, comprises grooves of a width equal to 5 mm and of a depth equal to 6.5 mm. The rubbery material of the two axially exterior portions of the tread of this tyre A, which does not conform to the invention, which is intended to be in contact with the ground during running is a material characterized by its high stiffness able to achieve a good compromise between wear and behaviour performance. The properties of this rubbery material are a Shore hardness equal to 67, and a tan (δ) max equal to 0.35.

Tyre B, according to the invention, is in all respects identical to tyre A except that the rubbery material of the two exterior portions of the tread of this tyre B according to the invention, which material is intended to be in contact with the ground during running, is a material characterized by its low stiffness: The properties of this rubbery material are a Shore hardness equal to 52, and a tan (δ) max equal to 0.17.

The conditions used for the calculation reproduce the running conditions of a front tyre on the outside of the bend, namely the tyre that is most heavily loaded in a passenger vehicle. Two situations were modelled, representing the conditions experienced by the tyre when the vehicle corners under the lateral acceleration of 0.3 g and of 0.7 g. At 0.3 g of transverse acceleration, the tyre experiences a lateral load (Fy) of 150 daN and a vertical load (Fz) of 568 daN, for a camber angle of 0.68°. At 0.7 g of transverse acceleration, the tyre experiences a lateral load (Fy) of 424 daN and a vertical load (Fz) of 701 daN, for a camber angle of 3°. The use, in tyre B according to the invention, of a rubbery material, in the two axially exterior portions of the tread, that is intended to come into contact with the ground, makes it possible to reduce the amplitude of the stresses calculated in the most heavily loaded monofilaments by 6.5% for both levels of stress loading as compared with these same stress loadings calculated under the same conditions of stress loading for tyre A.

Furthermore, the improvement in rolling resistance with the use of the material of the tread of tyre B compared with tyre A is at least equal to 15%.

1.-14. (canceled)

15. A tire for a passenger vehicle, the tire comprising:
a tread intended to come into contact with the ground via a tread surface and having an axial width LT,
the tread comprising two axially exterior portions, each having an axial width at most equal to 0.3 times the axial width LT, comprising at least one rubbery material intended to come into contact with the ground during running,
at least one axially exterior portion comprising axially exterior cuts, an axially exterior cut forming a space opening onto the tread surface and being delimited by at least two main lateral faces connected by a bottom face, and
the axially exterior cuts having a depth defined by the maximum radial distance between the tread surface and the bottom face; and
a crown reinforcement radially on the inside of the tread,
the crown reinforcement comprising a working reinforcement and a hoop reinforcement,
the working reinforcement being made up of two working layers, each comprising reinforcing elements which are coated in an elastomeric material, mutually parallel and respectively form, with a circumferential direction of the tire, an oriented angle at least equal to 20° and at most equal to 50°, in terms of absolute value, and of opposite sign from one layer to the next,
the reinforcing elements in each ply being made up of individual metal threads or monofilaments having a cross-section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm, and
the hoop reinforcement comprising at least one hooping layer comprising reinforcing elements which are mutually parallel and form, with the circumferential direction of the tire, an angle at most equal to 10°, in terms of absolute value,
wherein the breaking strength R_{C} of each working layer is at least equal to 30,000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm, and
wherein, in at least one of the two axially exterior portions, the at least one rubbery material intended to be in contact with the ground during running has a Shore hardness at least equal to 48 and at most equal to 60.

16. The tire according to claim 15, wherein the at least one rubbery material, in at least one of the two axially exterior portions and intended to be in contact with the ground during running, has a dynamic property tan(d)max measured at 23° C. at least equal to 0.12 and at most equal to 0.30.

17. The tire according to claim 15, wherein the depth of the axially exterior cuts is at least equal to 5 mm and are spaced apart, in the circumferential direction of the tire, by a circumferential spacing at least equal to 4 mm.

18. The tire according to claim 15, wherein the axially exterior cuts are spaced apart, in the circumferential direction of the tire, by a circumferential spacing at most equal to 50 mm.

19. The tire according to claim 15, wherein the depth of the axially exterior cuts is at most equal to 8 mm.

20. The tire according to claim 15, wherein a radial distance between the bottom face of the axially exterior cuts and the crown reinforcement is at least equal to 1 mm.

21. The tire according to claim 15, wherein a radial distance between the bottom face of the axially exterior cuts and the crown reinforcement is at most equal to 3.5 mm.

22. The tire according to any claim 15, wherein the axial width of each of the two axially exterior portions of the tread are at most equal to 0.2 times the axial width LT.

23. The tire according to claim 15, wherein each working layer comprises reinforcing elements made up of individual metal threads or monofilaments having a diameter at least equal to 0.3 mm and at most equal to 0.37 mm.

24. The tire according to claim 15, wherein each working layer comprises reinforcing elements which form, with the circumferential direction of the tire, an angle at least equal to 22° and at most equal to 35°.

25. The tire according to claim 15, wherein the density of the reinforcing elements in each working layer is at least equal to 120 threads per dm and at most equal to 180 threads per dm.

26. The tire according to claim 15, wherein the reinforcing elements of the working layers are made of steel.

27. The tire according to claim 26, wherein the steel is carbon steel.

28. The tire according to claim 15, wherein the reinforcing elements of the at least one hooping layer are made of textile.

29. The tire according to claim 28, wherein the textile is selected from the group consisting of aliphatic polyamide, aromatic polyamide, combination of aliphatic polyamide and aromatic polyamide, polyethylene terephthalate and rayon type.

30. The tire according to claim 15, wherein the hoop reinforcement is radially on the outside of the working reinforcement.
